(19) United States
(12) Patent Application Publication
(10) Pub. No.: US 2025/0292260 A1
(43) Pub. Date: Sep. 18, 2025

(54) RAISED REAL-TIME PAYMENTS FOR TRUSTED DEVICES

(71) Applicant: Wells Fargo Bank, N.A., San Francisco, CA (US)

(72) Inventors: William Blakely Belchee, Charlotte, NC (US); Matthew S. Brookshire, Cottonwood Heights, UT (US); John Andrew Chuprevich, Davidson, NC (US); Daniel Sanford, Charlotte, NC (US); Christopher Gaston Seagram, Frisco, TX (US); Matthew N. Wheeler, Charlotte, NC (US)

(21) Appl. No.: 18/603,480

(22) Filed: Mar. 13, 2024

(51) Int. Cl. G06Q 20/40; G06Q 20/32; G06Q 20/38

(52) U.S. Cl. CPC G06Q 20/405; G06Q 20/3276; G06Q 20/3278; G06Q 20/388; G06Q 20/4014; G06Q 20/4016

(57) ABSTRACT

Systems and techniques may be used for transaction limit management based on trust relationships in financial transactions. An example technique may include receiving data obtained by a user device interacting with a merchant device, such as scanning a QR code or using near-field communication (NFC). The example technique may include processing the data to identify the user device within a financial transaction system linked to a merchant point-of-sale (POS) system. The example technique may further include analyzing the transaction history between the user device and the merchant device to establish a trust level and determine the trustworthiness of the user device, wherein an increase in a transaction limit may be approved upon establishing a sufficient trust level.

### TECHNICAL FIELD

The present disclosure generally relates to the field of digital financial transactions, specifically to methods for enhancing security and transaction limits in financial systems by establishing trust levels based on a transaction history between user and merchant devices.

### BACKGROUND

The field of financial transactions, especially digital and mobile transactions, has undergone significant advancements with the introduction of advanced security measures.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 illustrates a system for dynamically changing a transaction limit in a transaction, according to various examples.

FIG. 2 illustrates an example merchant device interface showing options for initiating a transaction with a user device, according to various examples.

FIG. 3 illustrates an example merchant device interface showing options for selecting an identity verification method used to identify a user device, according to various examples.

FIG. 4 illustrates an example data flow diagram for calculating a trust score based on device interactions or historical transaction data, according to various examples.

FIG. 5 illustrates a machine learning engine for training and execution related to calculating a trust score for a transaction, according to various examples.

FIG. 6 illustrates a flowchart showing a technique for dynamically adjusting a transaction limit based on a trust score, according to various examples.

FIG. 7 illustrates generally an example of a block diagram of a machine upon which any one or more of the techniques discussed herein may perform, according to various examples.

### DETAILED DESCRIPTION

A significant challenge in financial transactions lies in the inherent limitations of static transaction limits, which lack the flexibility to be adapted. Some transactions are more likely to be secure than others. When enhanced security is predicted or determined, such as in transactions conducted between devices that have established a history of trust, a higher transaction limit may be desirable by the devices or a transaction facilitator (e.g., a bank). Traditional transaction limits do not allow for safer, higher-value transactions between such trusted devices.

To address these and other challenges, the systems and techniques discussed herein provide an approach for dynamically increasing transaction limits in real-time, such as based on a history of transactions between user and merchant devices. Trust can be derived from a financial institution's trust in a user or merchant device, or mutual trust between user and merchant devices, for example as evidenced by their transaction history. Transaction histories and device interactions may be analyzed to determine a trust score that indicates a level of security for a transaction. The trust score may be used to dynamically adjust a transaction limit, for example when a trust score threshold is met or exceeded.

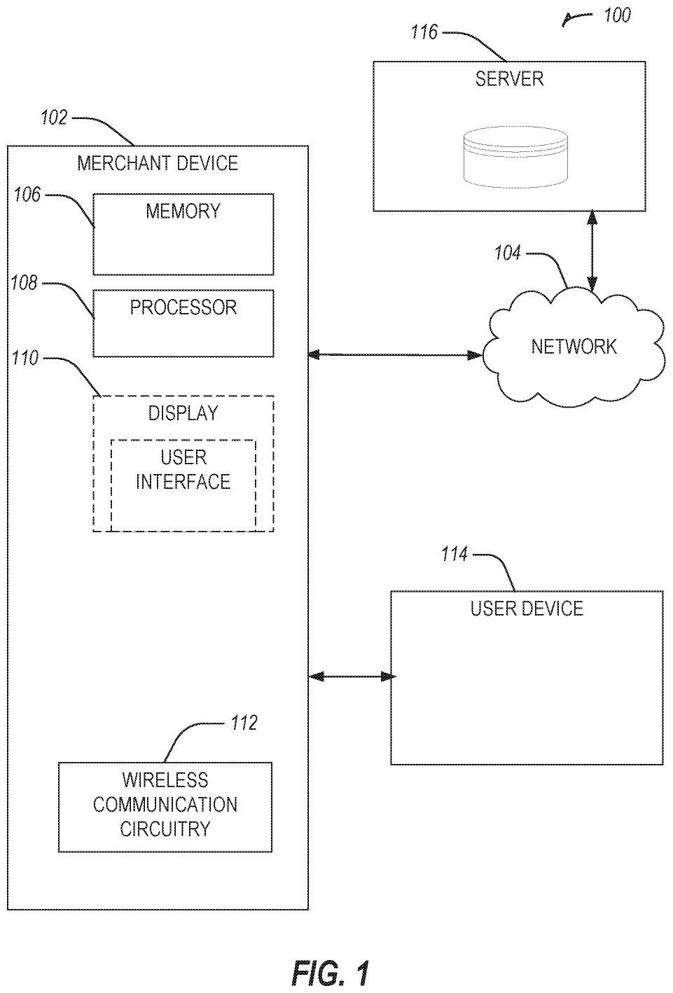

FIG. 1 illustrates a system 100 for dynamically adjusting a customer's transaction limit based on a trust score assessment in financial transactions, according to various examples. The system 100 includes a merchant device 102, including one or more components, conducting a transaction with a user device 114. The merchant device 102 includes memory 106 for storing data and instructions, a processor 108, optionally a display 110, and wireless communication circuitry 112. The display 110 may be used to present a user interface, such as a graphical user interface (GUI). The GUI may be used to present one or more selectable options, information, or the like. The merchant device 102 may include wireless communication circuitry 112 for conducting a transaction with a user device 114.

The system 100 may include a server 116. The server 116 may be a single device, may include multiple devices, may be located in different or same locations, etc. The merchant device 102 may communicate with the server 116 via a network 104 (e.g., the internet). The server 116 may store authentication information or information about the user device 114 relating to transactions between the merchant device 102 and the user device 114. The server 116 may implement a secure authentication technique, such as verifying the user device's identity by comparing identification data received from the merchant device 102 via the network 104 to stored account information. Through the network 104, the merchant device 102 can securely transmit identification data, received from the user device 114, to the server 116 and receive an authentication response.

A transaction may be initiated between the user device 114 and the merchant device 102 via one or more techniques, such as by scanning a QR code, via a proximate communication channel (e.g., via near field communication (NFC), via another radio frequency identification (RFID) protocol, over a Bluetooth connection, via Wi-Fi, via another peer-to-peer communication protocol, Apple Pay from Apple, Google Pay from Alphabet, or the like), via a entry of a code, via phone call, via text message (e.g., SMS, etc.), or the like. In some examples, initiating a transaction may include a selection on the display 110, such as entering or confirming a transaction amount, selecting a transaction item or service, or the like.

After a transaction is initiated, a transaction amount may be identified (e.g., by the merchant device 102 or by the server 116. In some examples, the transaction amount may exceed a transaction limit. The transaction limit may be established or saved at the server 116. The transaction limit may be established or modified based on the user device 114, the merchant device 102, a user of the user device 114, previous transactions between the user or the user device 114 and the merchant device 102, a transaction type, a time of day, a location of the user device 114 or the merchant device 102, a risk requirement, a login status of the user device 114 (e.g., with a banking app), or the like.

The transaction amount can be compared to the transaction limit to determine whether the transaction may proceed without raising the transaction limit. When the transaction amount is below the transaction limit, the transaction can proceed (e.g., subject to other considerations, such as authentication, security, available funds or credit, etc.). When the transaction amount exceeds the transaction limit, the transaction can be further evaluated according to a trust score or security metric, such as described herein.

A trust score, as described herein, can refer to a dynamically calculated value representing the perceived trustworthiness of a transaction participant, based on historical transaction data, behavioral patterns, or various other risk assessment criteria. In some embodiments, the trust score can be displayed as a numeric value, ranging, for example, from 0 to 100, where higher scores indicate a higher level of trustworthiness, for example based on past transaction behaviors or security verifications. Such a scoring system may be used to determine a granular assessment for differential treatment of transactions, such as those that fall within various score ranges. For example, a trust score above 80 can signal a low risk of fraud, while scores below 50 can trigger additional verification steps or limit the transaction amount as a precautionary measure against potential risk.

In other examples, the trust score can be used to categorize a user devices into tiers that are associated with specific transaction privileges or limits. The trust score can include a qualitative descriptor with the numerical value. For example, a score of 80 can include a descriptor, such as “Frequent Transactions” or “No Chargebacks” to highlight the positive behaviors contributing to the score.

In some examples, the trust score can be dynamically adjusted in real-time in order to reflect current transaction data or interactions. For example, a series of successful high-value transactions can result in an immediate increase in the trust score, while a reported unauthorized transaction can lower it.

A security metric, as described herein, may refer to a quantitative measure of the security posture of a transaction or device based on predefined parameters. It can encompass a broader range of data points than the trust score. For example, the security metric can be based on the merchant device's security protocols, location of the device, or time of the transaction. In other examples, the security metric can be displayed as a numerical value where the metric can range, for example, from 0 to 100. For example, a security metric of 85 can indicate that the transaction has passed a security check, is being conducted in a low-risk location, or is occurring during a typical shopping hour, or a combination of these factors.

In other examples, the security metric can be displayed as a composite index of sub-metrics, each evaluating a different aspect of security. For example, a transaction can have an encryption sub-metric score, an authentication sub-metric score, or a location-based sub-metric score. These sub-metrics can then be aggregated into an overall security metric that incorporates specific strengths or vulnerabilities of a transaction or user device. In some examples, the security metric can include a categorical label with a numerical value to provide context to the score. For example, a security metric of 85 can include a label such as “Verified User” or “High-Risk Location” to give an indicator of the factors contributing to the generated score.

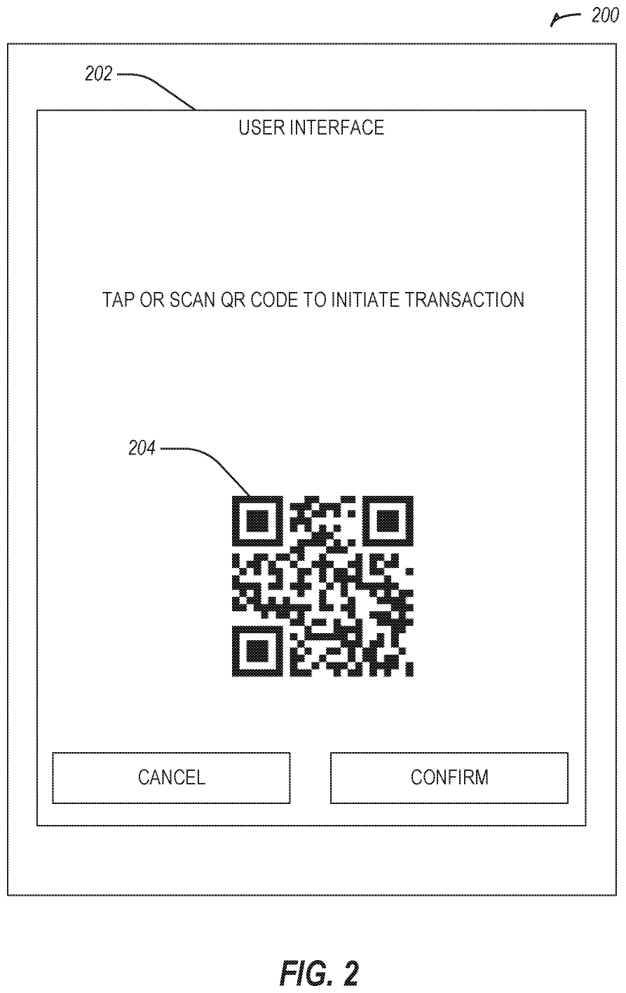

FIG. 2 illustrates an example merchant device 200 with a user interface 202 showing options for initiating a transaction with a user device, according to various examples. These options may include scanning a QR code, entering a phone number associated with the user device, tapping the user device to the merchant device 200 (e.g., for NFC-based data transfer), via a proximate communication channel, via a entry of a code, via phone call, via text message, or the like. In some examples, the user interface 202 may display a current transaction limit or offer a merchant operating the merchant device 200 an option to initiate a transaction limit increase request for the transaction.

In some examples, the user interface 202 can display a real-time or near real-time transaction status update. The user interface 202 can be used for monitoring the progress of a transaction from initiation to completion. The user interface 202 can provide a selectable indication to request a transaction limit increase. The user interface 202 can be used for configuration of security settings, such as an identity verification technique, for example based on a transaction type or amount. In other examples, the user interface 202 can be used to offer personalized services or promotions based on purchasing patterns of the user device, such as by suggesting related products or services, or offering push notification loyalty discounts through the user interface 202.

In some examples, a user can initiate a transaction by scanning a QR code 204 displayed on the user interface 202. After scanning, the QR code can direct a user to a website or other resource, such as connection information or provide the user device with transaction information (e.g., a merchant identifier, a transaction identifier, etc.). The user device then initiates a secure communication channel to the merchant device or to a server in order to initiate the transaction by transmitting identification data obtained via the QR code.

In other examples, a user can initiate a transaction via an NFC communication with a merchant device. The NFC communication can occur automatically, such as when the user device is within proximity of the merchant device (e.g., when the merchant device or the user device is open to receiving an NFC communication or when the merchant device or the user device is sending an NFC communication). The NFC communication can include bi-directional communication or uni-directional communication. For example, information may be passed from the merchant device to the user device, from the user device to the merchant device, or between both devices.

In some examples, the server receives the identification data from the user device, either via the merchant device or from the user device, and processes it via a machine learning model to calculate a trust score based on historical transaction data. The server can analyze the user device's transaction history for patterns of reliable transactions, an absence of disputes or chargebacks, or payment history.

In other examples, a machine learning model may be used to calculate a security metric based on the merchant device's security protocols and risk requirements. The server can then approve an increase to the transaction limit to permit the transition to occur and notify both the user and merchant devices. For example, the user and merchant devices can receive a notification in the user interface 202 to indicate the calculated trust score or security metric, and decision regarding the transaction limit increase.

In some embodiments, a user device can be tapped against a merchant device and near-field communication technology may be employed to enable a direct exchange of the user device's identification data. The merchant device processes the transmitted identification data and communicates with the server to check against transaction limits and calculate a trust score or security metric to evaluate the user device for a transaction limit increase.

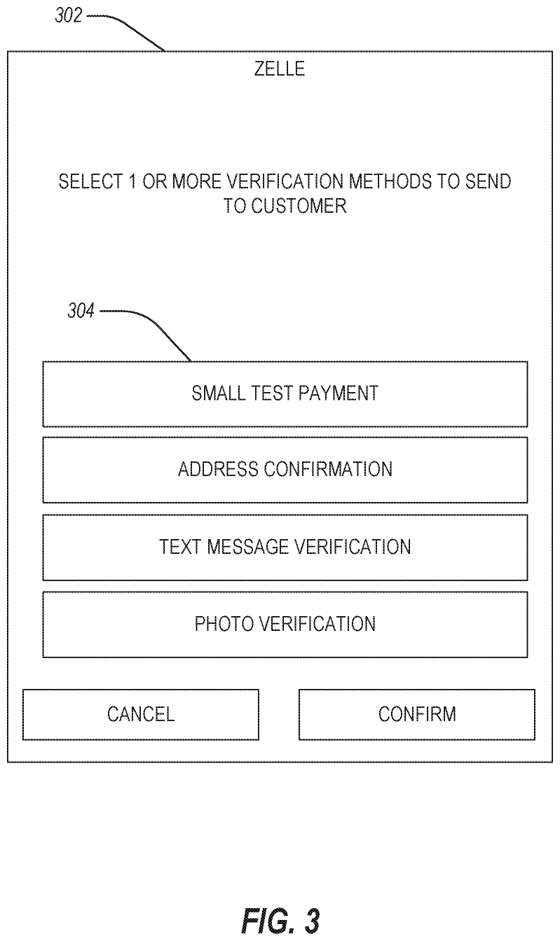

FIG. 3 illustrates an example merchant device interface 302 showing options for selecting an identity verification method used to identify a user device, according to various examples. The interface 302 can present options 304 to authenticate a user device, such as biometric verification, PIN entry, a security question, a small payment test, address confirmation, text message verification, or photo verification. In some examples, one or more verification methods can be selected on the interface 302, for example to set a primary and secondary verification method. In these examples, when the primary method fails or is inconclusive, the secondary method can be initiated automatically, such as without requiring manual intervention. In some examples, the interface 302 can include real-time feedback on a verification process to visually indicate a success or failure of an authentication attempt. In some examples, when additional information is required for a selected verification method, a merchant device may initiate a secure message exchange with a customer device using the interface 302. The interface 302 can be integrated with an external verification service, such as a digital ID verification service.

In some examples, the merchant device may select a small payment test. Upon selection, the merchant device can initiate a minor transaction (e.g., a penny, a few pennies, etc.) to verify a financial account of the user device. The minor transaction can prompt the user device to verify the transaction amount through their financial institution or a short message service (SMS) notification from a bank. In some examples, confirmation of this charge by the customer may be communicated back to the merchant device via a user interface. In another example, the failure by the user device to verify the transaction amount can halt the transaction and display a notification to the merchant device via the user interface that the transaction has been canceled.

In another example, the merchant device can select an address confirmation verification method for the user device. The user can be prompted to enter a billing or shipping address, for example on the interface 302 or on the user device. The address may be transmitted to the server for verification against a previously stored address. A successful matching of the address confirms the user device. Any discrepancies can be displayed on the interface 302 for the merchant to take further action or allow correction, such as when there is not an exact match.

In another example, the merchant device may select text message verification and trigger the server to send a one-time passcode (OTP) to the user device. Upon entering the OTP on the merchant device via the interface 302, the transaction is authenticated. Entering an incorrect OTP can result in a failed verification status being displayed on the interface 302.

In another example, a customer may provide a live photo or document image using a merchant device to be compared against pre-stored images or documents associated with the customer's account. Successful verification allows the transaction to continue. In some examples, a mismatch results in a verification failure and the interface 302 can display alternative verification options.

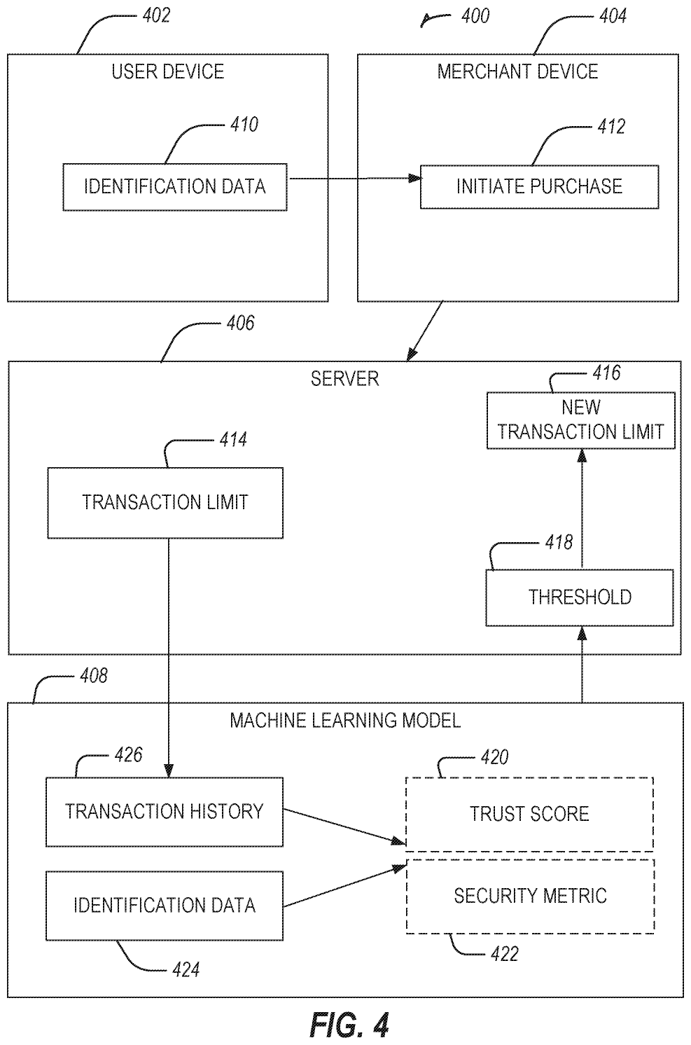

FIG. 4 illustrates an example data flow diagram 400 for calculating a trust score based on device interactions or historical transaction data, according to various examples. A server 406 determines a trust score 420 or a security metric 422 using data related to a merchant device 404 or a user device 402, for example from data stored in a database. In some examples, the user device 402 can initiate a purchase with an initiate purchase protocol 412 with the merchant device 404 by scanning a QR code displayed on the merchant device 404 or via NFC protocol communication to transmit identification data 410. For example, the user de vice 402 can scan a QR code displayed on the merchant device 404 causing information sufficient to identify the merchant and specific transaction details to allow the identification data 410 to be sent to the merchant device 404. The user device 402 can initiate the purchase by bringing the user device 402 into close proximity with the merchant device 404, creating a secure communication channel between the devices to transmit the identification data 410.

In response to the user device 402 initiating the purchase, the server may receive identification data 410 from the merchant device 404 or the user device 402, such as including information about a current transaction or previous transactions. The identification data 410 can include a user identifier, such as an account number, a username, a device ID, or the like to uniquely identify the user device 402. The identification data 410 can include transaction-specific data, such as a transaction amount, a timestamp, or the like. The server 406 may use the trust score 420 or the security metric 422 to dynamically change a transaction limit 414 for a transaction (or for the user device in general). In some examples, the server 406 may analyze historical transaction data to identify a pattern, a behavior, or some other indicator of risk to assign a trust score or a security metric. In some examples, contextual data such as a time of a transaction, a location of a transaction, or a device usage pattern may be analyzed to determine a trust score or a security metric for the user device.

The trust score 420 or security metric 422 calculation may incorporate user feedback, such as a report of an unauthorized transaction or a confirmed legitimate transaction, to further refine the trust assessment.

The generated trust score 420 or security metric 422 may be used to adjust the transaction limit 414, for example to a new transaction limit 416. In some examples, the trust score 420 or security metric 422 may be part of a dynamic feedback loop such as by using a transaction outcome to influence a future calculation. For example, when a previous transaction was approved with a high trust score 420 or security metric 422 is later disputed or flagged as fraudulent by either the user device 402 or the merchant device 404, the trust score 420 or security metric 422 may be modified (e.g., lowered). The server may provide a merchant with an insight derived from the trust score 420 or security metric 422 calculation, such as by offering a recommendation for improved security practices or by highlighting a specific transaction pattern that may be impacting a user device trust score 420 or security metric 422.

In some examples, a machine learning model 408 is used to generate the trust score 420 or security metric 422. The machine learning model 408 can analyze transaction data, such as outcomes, user behaviors, merchant interactions, or various security events, to learn and identify patterns that can indicate trustworthy or risky transactions. in some examples, the model may analyze data over time, such that the model can be improved with further training. For example, the model can analyze patterns of disputed transactions, frequent locations, time stamps, or transaction amounts to determine the trust score 420 or security metric 422. In some examples, the machine learning model 408 can use transaction history 426 corresponding to the identification data 424 to determine the trust score 420 or security metric 422.

In some examples, the machine learning model 408 can generate a recommended personalized transaction limit adjustment based on an individual user profile. For example, a user device with a history of secure and undisputed transactions can have a transaction limit dynamically increased. Patterns of irregular or risky behavior can lead to a more conservative limit, for example until positive behavior patterns reestablish a higher trust score 420 or security metric 422.

In some examples, the machine learning model 408 can output information used by the server 406 to provide a targeted recommendation to the user device, for example through the merchant device interface. For example, when the machine learning model 408 determines that the trust score 420 or security metric 422 is low for the user device 402, such as due to frequent transaction disputes, irregular transaction patterns, or a lack of recent transactions, the machine learning model 408 output can be used to automatically generate specific advice tailored to address these issues. Advice can include a recommendation to verify recent transactions as legitimate or illegitimate. In other examples, when the machine learning model 408 identifies a low trust score 420 or security metric 422 is a result of transactions in high-risk locations, a suggestion may be output that transactions be conducted through more secure channels or that an identity be verified for transactions in the identified areas.

The trust score 420 or the security metric 422 may be compared to a threshold 418, in some examples. The threshold 418 may be selected by a merchant (e.g., via the merchant device 404), by a financial institution (e.g., via the server 406), by a user (e.g., via the user device 402), according to a transaction parameter (e.g., frequency, location, time, payment method, etc.), according to a combination of devices or entities, or the like. For example, a first threshold may be set for the user device 402 any time it is interacting with a new merchant device, while a different (e.g., lower) threshold may be set for the user device 402 interacting with a previously interacted-with merchant device. In examples where the trust score 420 or the security metric 422 satisfies the threshold 418 (e.g., exceeds the threshold 418), a transaction limit may be increased. The threshold 418 may correspond to how risky a particular transaction is, with higher thresholds representing lower risk tolerance (e.g., fewer transactions will be allowed to have an increased limit). A lower threshold may correspond to a larger propensity for risk taking, allowing more transactions to have increased transaction limits.

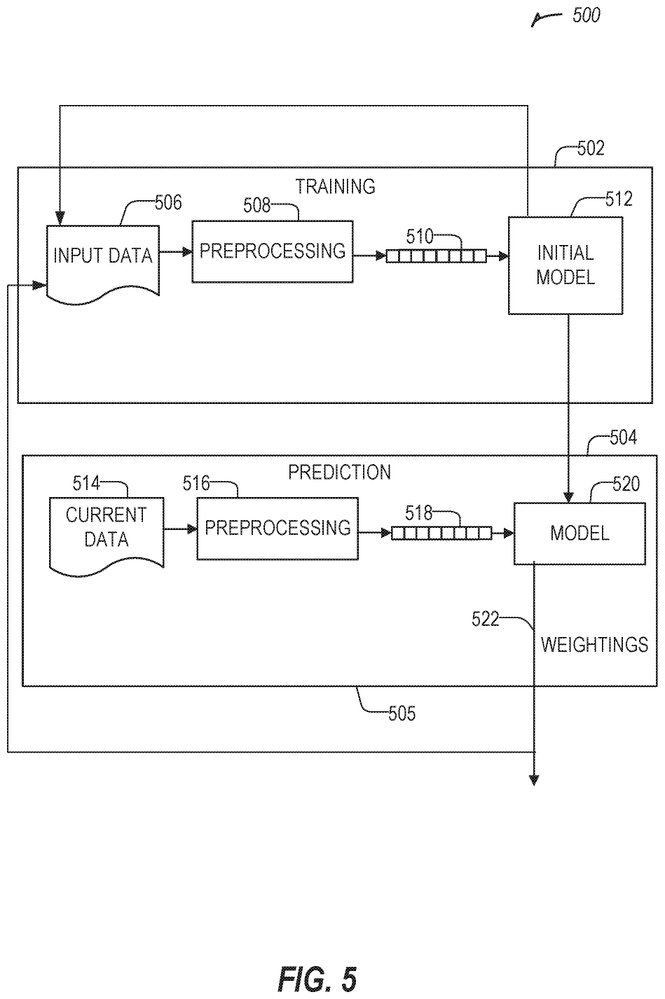

FIG. 5 illustrates a machine learning engine for training and execution related to calculating a trust score or security metric for a transaction, according to various examples. The machine learning engine may be deployed to execute at a mobile device (e.g., a cell phone) or a computer (e.g., an orchestrator server). FIG. 5 shows an example machine learning engine 500 according to some examples of the present disclosure.

The machine learning model includes a training engine 502 and a prediction engine 504. Training engine 502 uses input data 506, for example after undergoing preprocessing component 508, to determine one or more features 510. The one or more features 510 may be used to generate the initial model 512, which may be updated iteratively or with future labeled or unlabeled data (e.g., during reinforcement learning), for example to improve the performance of the prediction engine 504 or the initial model 512. An improved model may be redeployed for use.

The input data 506 may include user identification data, historical transaction amounts or frequencies, timestamps, locations, user feedback, or the like. The input data 506 may also include a type of user device (e.g., mobile phone, tablet, etc.). In some examples, the input data 506 may include user verification status, transaction type (e.g., in-store purchases or online orders), or a user-initiated action (e.g., payment confirmation, account change, or chargeback).

In the prediction engine 504, current data 514 (e.g., information received in an authentication attempt, such as via an API, which may include user identification data, etc.) may be input to preprocessing component 516. In some examples, preprocessing component 516 and preprocessing component 508 are the same. The prediction engine 504 produces feature vector 518 from the preprocessed current data, which is input into the model 520 to generate one or more criteria weightings 522. The criteria weightings 522 may be used to output a prediction, as discussed further below.

The training engine 502 may operate in an offline manner to train the model 520 (e.g., on a server). The prediction engine 504 may be designed to operate in an online manner (e.g., in real-time, at a mobile device, on a wearable device, etc.). In some examples, the model 520 may be periodically updated via additional training (e.g., via updated input data 506) or based on identified future data, such as by using reinforcement learning to personalize a general model (e.g., the initial model 512) to a particular user.

Labels for the input data 506 may include an indication of whether a transaction was fraudulent or not. Other label data may include an indication of increased transaction limits that resulted in positive or negative outcomes. Other labels may include an indication of an outcome of a past transaction, such as successful, flagged for review, or fraudulent.

The initial model 512 may be updated using further input data 506 until a satisfactory model 520 is generated. The model 520 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 502 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 502. In an example embodiment, a regression model is used and the model 520 is a vector of coefficients corresponding to a learned importance for each of the features in the vector of features 510, 518. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 520 may output a prediction of a trust score, a security metric, an indication of whether to increase a transaction limit, or the like.

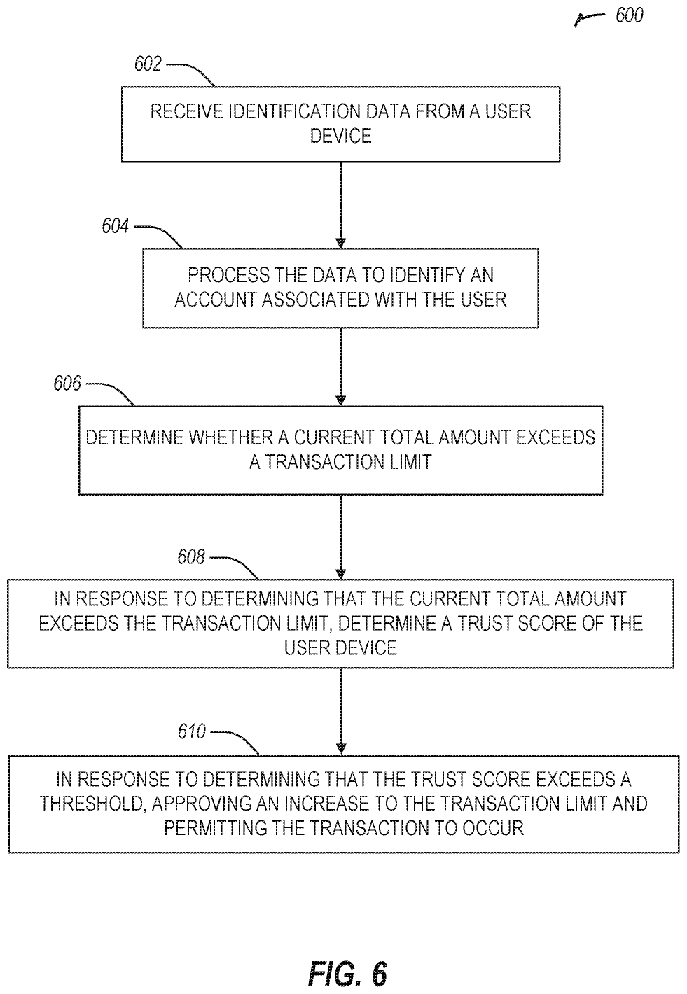

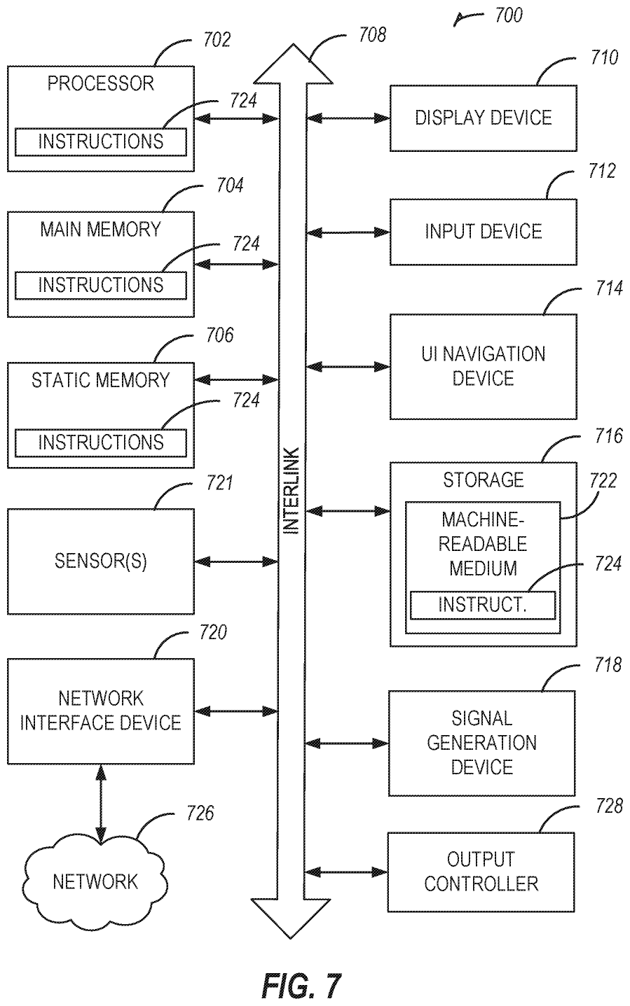

FIG. 6 illustrates a flowchart showing a technique 600 for dynamically adjusting a transaction limit based on a trust score, according to various examples. In an example, operations of the technique 600 may be performed by processing circuitry, for example, by executing instructions stored in memory. The processing circuitry may include a processor, a system on a chip, or other circuitry (e.g., wiring). For example, the technique 600 may be performed by processing circuitry of a device (or one or more hardware or software components thereof), such as those illustrated and described with reference to FIG. 1 or 7.

The technique 600 includes an operation 602 to receive identification data from a user device. The data may be obtained in response to a QR code being scanned by the user device at a merchant device. In other examples, the data may be obtained via an NFC protocol communication.

The technique 600 includes an operation 604 to process the data, for example by a server, to identify an account associated with the user device. Operation 604 may include processing the data to identify a transaction initiated at the merchant device corresponding to the account.

The technique 600 includes an operation 606 to determine whether a current total amount, for example corresponding to the transaction, exceeds a transaction limit. The transaction limit may be a limit set by a financial institution or a personalized limit set by a user or a merchant, or according to a particular transaction.

The technique 600 includes an operation 608 to, in response to determining that the current total amount exceeds the transaction limit, determine a trust score or a security metric of the user device. In some examples, the trust score or security metric is generated using a trained machine learning model.

The technique 600 includes an operation 610 to, in response to determining that the trust score or the security metric satisfies a threshold, approving an increase to the transaction limit, the increase to the transaction limit being sufficient to permit the transaction to occur with the merchant device. In an example, the technique 600 includes an operation to change the threshold based on a risk requirement. The operation 610 may include comprising changing the increase to the transaction limit based on a transaction type of the transaction. In an example, operation 610 may include, before approving the increase to the transaction limit, initiating a challenge to the user device, the challenge based on a merchant selected identity verification option. In some examples, the transaction limit is raised over a period of time based on a historical frequency or volume of transactions between the user device and the merchant device.

The technique 600 may include sending a plurality of identity verification options to the merchant device for selection, the plurality of identity verification options including at least one of address confirmation, text message verification, photo verification, or a small payment test.

FIG. 7 illustrates generally an example of a block diagram of a machine 700 upon which any one or more of the techniques (e.g., methodologies) discussed herein may perform in accordance with some examples. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, alphanumeric input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 that is non-transitory on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: receiving, at a server from a user device, data obtained in response to a QR code being scanned by the user device at a merchant device; processing, by the server, the data to identify an account associated with the user device and a transaction initiated at the merchant device corresponding to the account; determining whether a current total amount corresponding to the transaction exceeds a transaction limit; in response to determining that the current total amount exceeds the transaction limit, determining a trust score for the transaction using a trained machine learning model; in response to determining that the trust score exceeds a threshold, approving, by the server, an increase to the transaction limit for the transaction initiated at the merchant device, the increase to the transaction limit being sufficient to permit the transaction to occur with the merchant device; and outputting an indication to permit the transaction to occur.

In Example 2, the subject matter of Example 1 includes, changing the threshold based on a risk requirement corresponding to the merchant device, including a transaction volume, a type of good or service sold, or a fraud rate.

In Example 3, the subject matter of Examples 1-2 includes, changing the increase to the transaction limit based on a transaction type of the transaction.

In Example 4, the subject matter of Examples 1-3 includes, sending a plurality of identity verification options to the merchant device for selection, the plurality of identity verification options including at least one of address confirmation, text message verification, photo verification, or a small payment test.

In Example 5, the subject matter of Examples 1-4 includes, before approving the increase to the transaction limit, initiating a challenge to the user device, the challenge based on a merchant selected identity verification option.

In Example 6, the subject matter of Examples 1-5 includes, wherein the transaction limit is raised over a period of time based on a historical frequency or volume of transactions between the user device and the merchant device.

Example 7 is a method comprising: receiving, at a server from a user device, data obtained in response to a QR code being scanned by the user device at a merchant device; processing, by the server, the data to identify an account associated with the user device and a transaction initiated at the merchant device corresponding to the account; determining whether a current total amount corresponding to the transaction exceeds a transaction limit; in response to determining that the current total amount exceeds the transaction limit, determining, using a trained machine learning model, a security metric of the merchant device based on one or more historical transactions between the merchant device and the user device; in response to determining that the security metric exceeds a threshold, approving, by the server, an increase to the transaction limit for the transaction initiated at the merchant device, the increase to the transaction limit being sufficient to permit the transaction to occur with the merchant device; and outputting an indication to permit the transaction to occur.

In Example 8, the subject matter of Example 7 includes, generating, by the server, a unique transaction code for the transaction, the unique transaction code used for authenticating the user device.

In Example 9, the subject matter of Examples 7-8 includes, wherein the security metric is calculated by analyzing at least one of a frequency of transactions, an average transaction value, or an absence of fraudulent transactions historically recorded between the merchant device and the user device.

In Example 10, the subject matter of Examples 7-9 includes, sending a notification by the server to the user device requesting additional user authentication when the security metric is within a predefined range below the threshold.

In Example 11, the subject matter of Examples 7-10 includes, dynamically adjusting the threshold required for the security metric to trigger an increase in the transaction limit based on at least one of a time of day, a location of the merchant device, or a type of transaction.

In Example 12, the subject matter of Examples 7-11 includes, changing the threshold based on a risk requirement corresponding to the merchant device, including a transaction volume, a type of good or service sold, or a fraud rate.

In Example 13, the subject matter of Examples 7-12 includes, changing the increase of the transaction based on a transaction type of the transaction.

In Example 14, the subject matter of Examples 7-13 includes, before approving the increase to the transaction limit, initiating a challenge to the user device, the challenge based on a merchant selected identity verification option.

In Example 15, the subject matter of Examples 7-14 includes, comparing, by the server, the data against a database of financial transactions made by the user device to identify the user device.

Example 16 is a method comprising: receiving, at a server from a user device, data obtained from a near-field communication (NFC) between the user device at a merchant device; processing, by the server, the data to identify an account associated with the user device and a transaction initiated at the merchant device corresponding to the account; determining whether a current total amount corresponding to the transaction exceeds a transaction limit; in response to determining that the current total amount exceeds the transaction limit, determining, using a trained machine learning model, a security metric of the merchant device based on one or more historical transactions between the merchant device and the user device; in response to determining that the security metric exceeds a threshold, approving, by the server, an increase to the transaction limit for the transaction initiated at the merchant device, the increase to the transaction limit being sufficient to permit the transaction to occur with the merchant device; and outputting an indication to permit the transaction to occur.

In Example 17, the subject matter of Example 16 includes, dynamically adjusting the threshold for the security metric based on a transaction limit associated with the user device, wherein a history of secure transactions corresponds to a lower threshold for approving a transaction limit increase.

In Example 18, the subject matter of Examples 16-17 includes, wherein determining the security metric includes analyzing a type of good or service involved in the transaction.

In Example 19, the subject matter of Examples 16-18 includes, wherein receiving the data includes receiving a unique device identifier (UDI) of the user device, the UDI used to authenticate the user device.

In Example 20, the subject matter of Examples 16-19 includes, wherein receiving the data includes receiving a timestamp of the transaction, the timestamp used to verify that the transaction was initiated within an acceptable time frame for the merchant device.

Example 21 is a method comprising: identifying, by a server, a history of previous financial transactions between a user device and a merchant device; analyzing, by the server, the previous financial transactions to establish a trust score of the user device; determining, by the server, the trust score of the user device; in response to determining that the trust score exceeds a threshold approving, by the server an increase to the transaction limit for the transaction initiated at the merchant device, the increase to the transaction limit being sufficient to permit the transaction to occur with the merchant device; and instructing, by the server, an increase in a transaction limit for financial transactions initiated from the user device to the merchant device.

In Example 22, the subject matter of Example 21 includes, wherein the trust score is established based on a frequency and reliability of previous financial transactions between the user device and the merchant device.

In Example 23, the subject matter of Examples 21-22 includes, identifying, by the server, a disputed transaction or a chargeback in the transaction history between the user device and the merchant device, wherein approving the increase includes determining that there are no disputed transactions or chargebacks.

In Example 24, the subject matter of Examples 21-23 includes, categorizing, by the server, types of transactions in a transaction history between the user device and the merchant device; and using the categorization to modify the trust score, with two or more types of transactions being weighted differently based on previously defined risk levels.

Example 25 is a method comprising: receiving, at a merchant device, identification data from a user device via a near-field communication transmission; transmitting the received identification data to a server for processing, wherein the data is used to identify the user device within a financial transaction system associated with the merchant device; initiating a financial transaction from the merchant device based on the identification data; receiving, from the server, an indication of an increase in a transaction limit for the initiated transaction; and processing the transaction.

In Example 26, the subject matter of Example 25 includes, displaying, on the merchant device, a confirmation request for the increased transaction limit before processing the transaction, wherein the confirmation includes details of the transaction limit increase and requires approval through the user device.

In Example 27, the subject matter of Examples 25-26 includes, receiving, at the merchant device, information from the server corresponding to categorization of previous transactions between the user device and the merchant device based on associated risk levels, wherein the categorization is used by the server to increase the transaction limit and the increase is communicated to the merchant device along with a rationale for the increase.

In Example 28, the subject matter of Examples 25-27 includes, wherein the identification data is encrypted when received at the merchant device.

Example 29 is at least one machine-readable medium including instructions that, when executed by processing circuitry, cause the processing circuitry to perform operations to implement of any of Examples 1-28.

Example 30 is an apparatus comprising means to implement of any of Examples 1-28.

Example 31 is a system to implement of any of Examples 1-28.

Example 32 is a method to implement of any of Examples 1-28.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
receiving, at a server from a user device, data obtained in response to a QR code being scanned by the user device at a merchant device;
processing, by the server, the data to identify an account associated with the user device and a transaction initiated at the merchant device corresponding to the account;
determining whether a current total amount corresponding to the transaction exceeds a transaction limit;
in response to determining that the current total amount exceeds the transaction limit, determining a trust score for the transaction using a trained machine learning model;
in response to determining that the trust score exceeds a threshold, approving, by the server, an increase to the transaction limit for the transaction initiated at the merchant device, the increase to the transaction limit being sufficient to permit the transaction to occur with the merchant device; and
outputting an indication to permit the transaction to occur.

2. The method of claim 1, further comprising changing the threshold based on a risk requirement corresponding to the merchant device, including a transaction volume, a type of good or service sold, or a fraud rate.

3. The method of claim 1, further comprising changing the increase to the transaction limit based on a transaction type of the transaction.

4. The method of claim 1, further comprising sending a plurality of identity verification options to the merchant device for selection, the plurality of identity verification options including at least one of address confirmation, text message verification, photo verification, or a small payment test.

5. The method of claim 1, further comprising, before approving the increase to the transaction limit, initiating a challenge to the user device, the challenge based on a merchant selected identity verification option.

6. The method of claim 1, wherein the transaction limit is raised over a period of time based on a historical frequency or volume of transactions between the user device and the merchant device.

7. A method comprising:
receiving, at a server from a user device, data obtained in response to a QR code being scanned by the user device at a merchant device;
processing, by the server, the data to identify an account associated with the user device and a transaction initiated at the merchant device corresponding to the account;
determining whether a current total amount corresponding to the transaction exceeds a transaction limit;
in response to determining that the current total amount exceeds the transaction limit, determining, using a trained machine learning model, a security metric of the merchant device based on one or more historical transactions between the merchant device and the user device;
in response to determining that the security metric exceeds a threshold, approving, by the server, an increase to the transaction limit for the transaction initiated at the merchant device, the increase to the transaction limit being sufficient to permit the transaction to occur with the merchant device; and
outputting an indication to permit the transaction to occur.

8. The method of claim 7, further comprising generating, by the server, a unique transaction code for the transaction, the unique transaction code used for authenticating the user device.

9. The method of claim 7, wherein the security metric is calculated by analyzing at least one of a frequency of transactions, an average transaction value, or an absence of fraudulent transactions historically recorded between the merchant device and the user device.

10. The method of claim 7, further comprising sending a notification by the server to the user device requesting additional user authentication when the security metric is within a predefined range below the threshold.

11. The method of claim 7, further comprising dynamically adjusting the threshold required for the security metric to trigger an increase in the transaction limit based on at least one of a time of day, a location of the merchant device, or a type of transaction.

12. The method of claim 7, further comprising changing the threshold based on a risk requirement corresponding to the merchant device, including a transaction volume, a type of good or service sold, or a fraud rate.

13. The method of claim 7, further comprising changing the increase of the transaction based on a transaction type of the transaction.

14. The method of claim 7, further comprising, before approving the increase to the transaction limit, initiating a challenge to the user device, the challenge based on a merchant selected identity verification option.

15. The method of claim 7, further comprising comparing, by the server, the data against a database of financial transactions made by the user device to identify the user device.

16. A method comprising:
receiving, at a server from a user device, data obtained from a near-field communication (NFC) between the user device at a merchant device;
processing, by the server, the data to identify an account associated with the user device and a transaction initiated at the merchant device corresponding to the account;
determining whether a current total amount corresponding to the transaction exceeds a transaction limit;
in response to determining that the current total amount exceeds the transaction limit, determining, using a trained machine learning model, a security metric of the merchant device based on one or more historical transactions between the merchant device and the user device;
in response to determining that the security metric exceeds a threshold, approving, by the server, an increase to the transaction limit for the transaction initiated at the merchant device, the increase to the transaction limit being sufficient to permit the transaction to occur with the merchant device; and
outputting an indication to permit the transaction to occur.

17. The method of claim 16, further comprising dynamically adjusting the threshold for the security metric based on a transaction limit associated with the user device, wherein a history of secure transactions corresponds to a lower threshold for approving a transaction limit increase.

18. The method of claim 16, wherein determining the security metric includes analyzing a type of good or service involved in the transaction.

19. The method of claim 16, wherein receiving the data includes receiving a unique device identifier (UDI) of the user device, the UDI used to authenticate the user device.

20. The method of claim 16, wherein receiving the data includes receiving a timestamp of the transaction, the timestamp used to verify that the transaction was initiated within an acceptable time frame for the merchant device.
